(19) United States
(12) Patent Application Publication
(10) Pub. No.: US 2025/0108743 A1
(43) Pub. Date: Apr. 3, 2025

(54) HEADREST FOR A MOTOR VEHICLE SEAT

(71) Applicant: TREVES PRODUCTS,SERVICES & INNOVATION, Paris (FR)

(72) Inventors: Eric BRILLON, Paris (FR); Xavier BONFILS, Paris (FR)

(21) Appl. No.: 18/727,759

(22) PCT Filed: Jan. 9, 2021
(86) PCT No.: PCT/EP2023/050338

§ 371 Date: Jul. 10, 2024

(30) Foreign Application Priority Data
Jan. 10, 2022 (FR) FR2200156
Apr. 14, 2022 (FR) FR2203483

(51) Int. Cl. B60N 2/879

(52) U.S. Cl. CPC B60N 2/879

(57) ABSTRACT

The invention relates to a headrest (1) for a motor vehicle seat, said headrest comprising a rigid structure for mounting said headrest at the top of the backrest of said seat, said structure being provided with at least one sound transmission plate (6), said plate being provided with an electrodynamic transducer (7) and being connected to said structure via an acoustic decoupling means (8) made of elastically deformable material, so as to prevent transmission of vibrations from said plate to said structure.

The invention concerns a headrest for a motor vehicle seat and an assembly for generating anti-noise in the passenger compartment of said vehicle.

It is known to produce a headrest for a motor vehicle seat, said headrest comprising a rigid structure for mounting said headrest at the top of the backrest of said seat.

It is also known that the headrest is fitted with at least one loudspeaker designed to emit a sound signal close to the head of a seat occupant.

In particular, the sound signal can be of the “anti-noise” type, so as to emit a sound in phase opposition to the noise generated inside the passenger compartment.

However, the disadvantages of a loudspeaker are that it takes up a lot of space, making it difficult to fit into a small piece such as a headrest, and that the headrest fitted with it becomes significantly heavier.

The aim of the invention is to provide a headrest that overcomes these disadvantages.

To this end, the invention proposes a headrest for a motor vehicle seat, said headrest comprising a rigid structure for mounting said headrest at the top of the backrest of said seat, said structure being provided with at least one sound transmission plate, said plate being:
provided with an electrodynamic transducer,
connected to said structure via an acoustic decoupling means made of elastically deformable material, so as to prevent transmission of vibrations from said plate to said structure.

In this description, the terms positioning in space (lateral, transverse, top, rear, . . . ) are taken to refer to the headrest positioned in the vehicle in the situation of use.

For the record, transduction is the operation of transforming one physical quantity into another, by means of a transducer that transforms energy received in a given form, such as electrical energy, into energy that can be used in a different form, such as acoustic energy.

The invention involves transforming an electrical signal into an acoustic signal, by using the rigid plate to which the transducer is attached as the radiation surface.

For the record, a transducer differs from a loudspeaker as follows:
a loudspeaker comprises a magnet fixedly mounted on a support and a flexible diaphragm attached to a coil, said diaphragm vibrating when said loudspeaker is powered,
a transducer comprises a coil fixedly mounted on a rigid plate and a magnet mounted via suspension means on said coil, so that said plate vibrates when said transducer is powered.

Ultimately, a loudspeaker is an autonomous system that generates sound independently of the environment in which it is mounted, whereas a transducer uses the support to which it is attached, in this case a rigid plate, to generate the expected sound.

With the proposed arrangement, the loudspeaker is replaced by a transducer which, as it is well known, takes up less space and is lighter in weight.

According to another aspect, the invention proposes an assembly for generating anti-noise in the passenger compartment of said vehicle.

Further features and advantages of the invention will become apparent from the following description, made with reference to the attached figures in which:

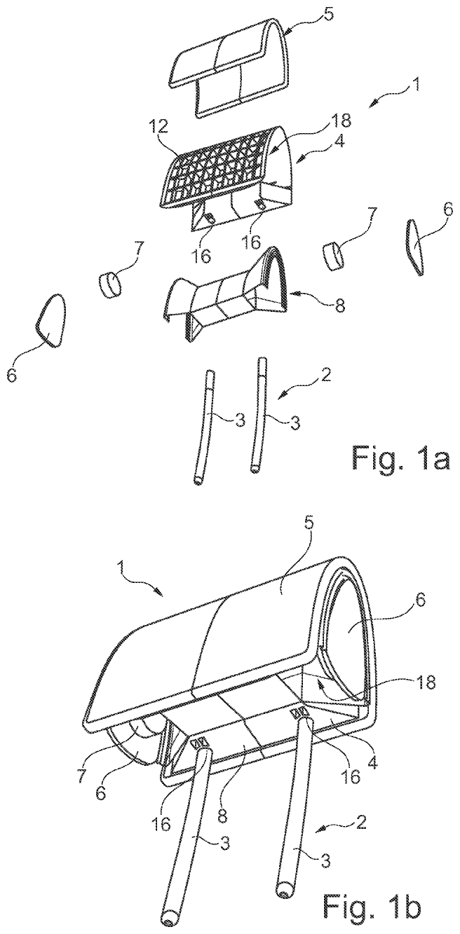

FIG. 1a and

FIG. 1 bare schematic exploded (FIG. 1a) and non-exploded (FIG. 1b) perspective views of a headrest according to a first embodiment,

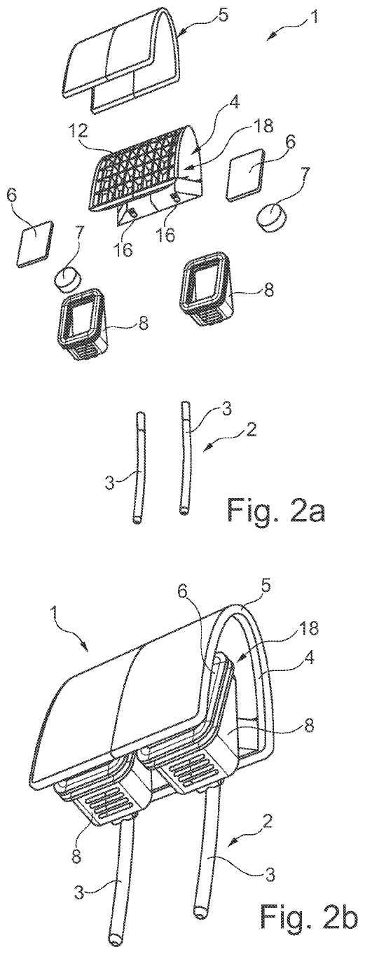

FIG. 2a and

FIG. 2b are schematic exploded (FIG. 2a) and non-exploded (FIG. 2b) perspective views of a headrest according to a second embodiment,

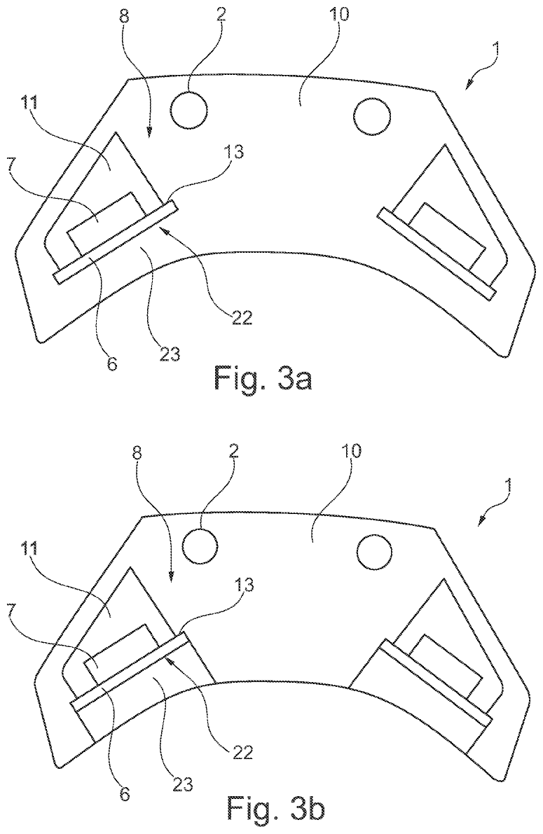

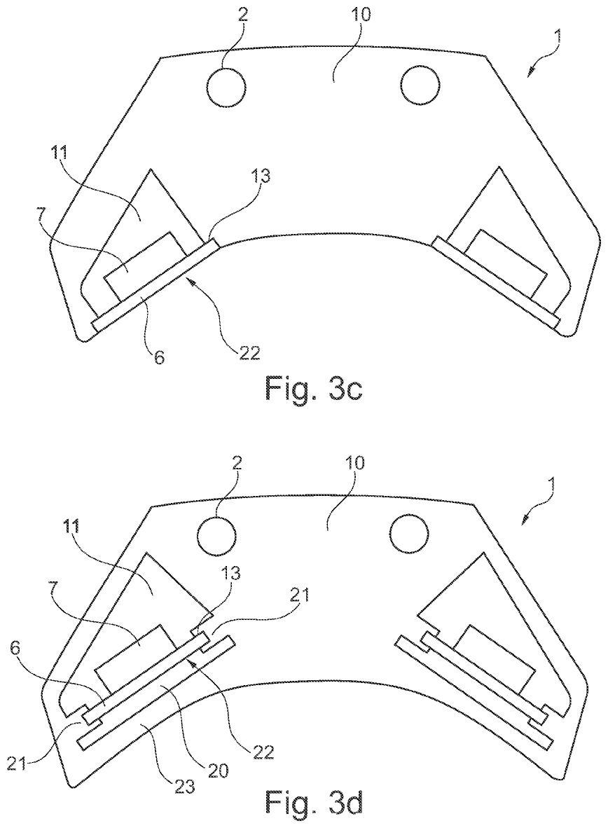

FIG. 3a,

FIG. 3b,

FIG. 3c and

FIG. 3d are schematic partial cross-sectional views of a headrest according to four variants of a third embodiment.

With reference to the figures, a headrest 1 for a motor vehicle seat is described, said headrest comprising a rigid structure for mounting said headrest at the top of the backrest of said seat, said structure being provided with at least one sound transmission plate 6, said plate being:
provided with an electrodynamic transducer 7—fixed, for example, by gluing, welding or fitting onto a receiving means provided on said plate for this purpose—,
connected to said structure via an acoustic decoupling means 8 made of elastically deformable material—in particular molded elastomer material, for example ethylene propylene diene monomer (EPDM), or foam, in particular polyurethane—so as to prevent transmission of vibrations from said plate to said structure.

In one embodiment, the plate 6 has a thickness of between 3 and 8 mm.

According to one embodiment, the plate 6 has a density of between 100 and 500 kg/m³.

With such thickness and/or density characteristics, we have a low-mass plate 6 that can be easily vibrated by the connected transducer.

In one embodiment, the plate 6 has a Young's modulus greater than 100 MPa. In one embodiment, the decoupling means 8 has a Young's modulus of less than kPa.

In one embodiment, the decoupling means 8 has a loss factor greater than 0.2.

According to the embodiments shown, the structure is provided with two plates 6 arranged laterally on either side, so as to place a transducer 7 on each side of the head of a seat occupant.

We now describe the first and second embodiments shown in FIGS. 1 and 2 respectively.

According to the embodiments shown in FIGS. 1 and 2, the structure comprises:
a frame 2 comprising two parallel metal rods 3,
a piece 4—in particular made of molded plastic material—for receiving a cushion 5 and absorbing energy in the event of a shock of an occupant's head, said rods each being nested in a respective housing 16 provided in said piece—here at the rear—, said piece having a general shape of a profile defining, in side view, an inverted U-shaped cross-section, so as to define a cavity 18, at least one transducer 7 being housed in said cavity.

According to the embodiments shown, the piece 4 is provided with a network of ribs 12, so as to reinforce its flexural rigidity.

In the embodiments shown, the ribs 12 are arranged in a lattice pattern.

According to one embodiment, the cushion 5 is in the form of a block of foam with a molded skin, the skin of said foam being arranged at the outside, said foam having a hardness greater than 25 shore A.

In particular, the foam can have a hardness of the order of 30 shore A.

In one embodiment, the foam of the block has a density of between 0.20 and 0.30, and in particular of the order of 0.25.

According to the embodiments shown, the cavity 18 opens outwards to form a “bass-reflex” system (adjustable by the size of the vent which is provided to allow said cavity to open outwards) when the plate 6 is vibrated by the connected transducer 7.

According to the first embodiment shown in FIGS. 1a and 1b, the decoupling means 8 is in one piece—in particular, it is obtained by molding—and extends transversely on either side of the cavity 18, two plates 6, each provided with a transducer 7, being respectively fixed to the lateral ends of said means.

In this embodiment, the plates 6 laterally conceal the cavity 18.

In an embodiment not shown, the plates 6 can be inclined so as to orientate the transducers 7 towards the ears of a seat occupant.

According to the second embodiment shown in FIGS. 2a and 2b, each of the rods 3 receives a respective decoupling means 8—in particular molded—arranged in the cavity 18, each of the decoupling means 8 receiving a plate 6 provided with a transducer 7.

According to this embodiment, the plates 6 are arranged in front of the decoupling means 8, with the piece 4 being perforated facing said plates so as to allow sound propagation towards the seat occupant.

In a variant not shown, the plates 6 can be arranged laterally on the decoupling means 8.

The third embodiment shown in FIGS. 3a to 3d is now described.

According to the variants of this third embodiment, the structure is formed by a metal frame 2, at least one plate 6 provided with a transducer 7 being connected to said frame via a decoupling means 8.

According to this third embodiment:
the headrest is provided with a padding block 10 made of elastically compressible foam,
said block is provided with at least one cavity 11,
said cavity has an opening 22 closed by a plate 6 fixed by its periphery 13
in particular by gluing—at the periphery of said opening,
the decoupling means 8 is formed by the foam of said block interposed between the frame 2 and said plate.

Not shown, the cavity 11 can be perforated to form a “bass-reflex” system as described above.

According to the variants shown in FIGS. 3a, 3b and 3d, the plate 6 is covered, opposite the cavity 11, by a layer of foam 23 blending into the overall volume of the block 10, said layer being:
either molded from said block, as shown in FIGS. 3a and 3d,
or formed, as shown in FIG. 3b, by a foam pad with a porosity greater than 0.95 and a resistivity to the passage of air of less than 5000 N·s·m⁻⁴, so as to improve the passage of acoustic waves.

According to the variant shown in FIG. 3c, the plate 6 is not covered by a layer of foam that blends into the overall volume of the block 10.

According to the variant shown in FIG. 3d, the plate 6 is arranged between the cavity 11 and an auxiliary cavity 20, said plate being fixed by its periphery 13 to a lip 21 moulded from the block 10, said lip surrounding said plate, so as to allow accentuated decoupling between said plate and the frame 2.

Not shown, in all variants of the third embodiment, an ultra-compressible gasket (with higher compressibility than the foam of the block 10) can be fitted between the periphery 13 of the plate 6 and the periphery of the opening 22, for improved decoupling at very low frequencies, in particular below 100 Hz.

Finally, an assembly for generating anti-noise in a passenger compartment of a motor vehicle is described, said assembly comprising a headrest 1 as previously described and an anti-noise production system connected to at least one transducer 7.

In one variant, the transducer 7 can be used to generate conventional noise, such as music, instead of an anti-noise.

1. Headrest (1) for a motor vehicle seat, said headrest comprising a rigid structure for mounting said headrest at the top of the backrest of said seat, said headrest being characterized in that said structure is provided with at least one sound transmission plate (6), said plate being:
provided with an electrodynamic transducer (7),
connected to said structure via an acoustic decoupling means (8) made of elastically deformable material, so as to prevent transmission of vibrations from said plate to said structure.

2. Headrest according to claim 1, characterized in that the structure is provided with two plates (6) arranged laterally on either side, so as to arrange a transducer (7) on each side of the head of a seat occupant.

3. Headrest according to claim 1, characterized in that the structure comprises:
a frame (2) comprising two parallel metal rods (3),
a piece (4) for receiving a cushion (5) and absorbing energy in the event of a shock of the head of an occupant, said rods each being nested in a respective housing (16) provided in said piece, said piece having a general profile shape defining in side view an inverted U-shaped cross-section, so as to define a cavity (18), at least one transducer (7) being housed in said cavity.

4. Headrest according to claim 2, characterized in that the decoupling means (8) is in one piece and extends transversely on either side in the cavity (18), two plates (6) each provided with a transducer (7) being respectively fixed to the lateral ends of said means.

5. Headrest according to claim 2, characterized in that each of the rods (3) receives a respective decoupling means (8) arranged in the cavity (18), each of the decoupling means (8) receiving a plate (6) provided with a transducer (7).

6. Headrest according to claim 1, characterized in that the structure is formed by a metal frame (2), at least one plate (6) provided with a transducer (7) being connected to said frame via a decoupling means (8).

7. Headrest according to claim 6, characterized in that:
it is provided with a padding block (10) made of elastically compressible foam, said block is provided with at least one cavity (11),
said cavity has an opening (22) closed by a plate (6) fixed by its periphery (13) at the periphery of said opening,
the decoupling means (8) is formed by the foam of said block interposed between the frame (2) and said plate.

8. Headrest according to claim 7, characterized in that the plate (6) is covered, opposite the cavity (11), by a layer of foam (23) blending into the overall volume of the block (10), said layer being:
either molded from said block,
or formed by a foam pad with a porosity greater than 0.95 and a resistivity to air passage of less than 5000 N·s·m⁻⁴, so as to improve the passage of acoustic waves.

9. Assembly for generating anti-noise in a passenger compartment of a motor vehicle, said assembly comprising a headrest (1) according to claim 1, and an anti-noise production system connected to at least one transducer (7).
